(19) United States
(12) Patent Application Publication
(10) Pub. No.: US 2021/0141424 A1
(43) Pub. Date: May 13, 2021

(54) Methods and Systems for Electronic Adaptation

(71) Applicants: Griffin Clark, Encinitas, CA (US); David Morelock, Escondido, CA (US)

(72) Inventors: Griffin Clark, Encinitas, CA (US); David Morelock, Escondido, CA (US)

(21) Appl. No.: 17/090,436

(22) Filed: Nov. 5, 2020

Related U.S. Application Data
(60) Provisional application No. 62/932,672, filed on Nov. 8, 2019.

(51) Int. Cl. G06F 1/16; H04M 1/02

(52) U.S. Cl. CPC G06F 1/1681; G06F 3/023; H04M 1/026

(57) ABSTRACT

Embodiments of the present invention may include an electronic device which may use a portable computer such as a smartphone perhaps to perform computations, while allowing a user to interact with the smartphone as though it was another form of computer, such as a tablet, laptop, or desktop. A non-limiting example of this may be a device in the shape of a laptop with an apparatus next to the screen perhaps specifically intended for holding a smartphone or the like.

### PRIORITY CLAIM

This application is a U.S. Nonprovisional patent application claiming priority to and the benefit of U.S. Provisional Application No. 62/932,672 filed Nov. 8, 2019, hereby incorporated by reference herein in its entirety.

### FIELD OF INVENTION

Generally, this invention may relate to an electronic device perhaps used to expand the usefulness of a portable computer by using it as a primary device and even simultaneously as an auxiliary display. Specifically, this device may be focused on allowing smartphones to be used in a manner similar to that of a laptop and may have added functionality of a secondary display.

### BACKGROUND OF THE INVENTION

As portable computers have become more computationally powerful and functional, many parties have thought about using an electronic accessory device to expand the functionality of portable computers, such as smartphones. Efforts in this regard date as far back to 1997, with U.S. Pat. No. 5,689,654, which may include a host device with a central processing unit (CPU), as well as an accessory device with a CPU. Since then, focus may have shifted towards a thin device capable of expanding the usefulness of a smartphone. To this effect, U.S. Pat. Nos. 8,600,437, 8,483,755, and 10,073,498 may detail devices in which a smartphone may be used in some shape or form as the primary computational device and may be housed in the base of the accessory device. Additionally, U.S. Pat. No. 8,725,205 may detail a similar device, perhaps with the addition that the smartphone may be used as a pointing device, which may be similar to a trackpad. One of the problems with this technique, however, may be that it demands an exact form factor from the smartphone in order to be physically compatible.

Many individuals today own both a portable computer such as a smartphone and a laptop, despite that their smartphone may be perfectly capable of being their primary computer from a computational standpoint. The reason most consumers choose to purchase a laptop may be because of the physical keyboard, larger screen size, and perhaps an extended battery life the laptop may provide.

There may be three primary problems that present themselves from a consumer's perspective. First, data may be fragmented across multiple devices and/or a cloud storage system, which may force users to manually control the location of their data. Second, both a smartphone and a laptop may have to be purchased, even though only one can be used at a time. Finally, only one display can be comfortably used at a time, perhaps causing attention to be switched frequently from one device to another, or one window to another, or the like.

### SUMMARY OF THE INVENTION

The present invention includes a variety of aspects, which may be selected in different combinations based upon the particular application or needs to be addressed. In various embodiments, the invention may include a device or even an accessory device which can be used to expand the usefulness or even the functionality of a portable computer perhaps by using it as a secondary display and even as a computational module. An accessory device may have two main panels. A first panel may elevate or may otherwise change angles upon use and may house a display. This panel may include a notch, tab, or other mechanism by which it may make it easier to grab onto the panel. A second panel may act as a base for the primary panel and may be used to stabilize it. This panel may contain a single input device or even a plurality of input devices. Examples of devices may include, but is not limited to, a keyboard, touchpad, biometric scanner, a plurality buttons, a plurality of switches, or the like.

A function of an accessory device may be to expand the usefulness of a portable computer. In order to do this, a device may use some, any combination thereof, or even all of the following attributes.

In one form, an accessory device may provide a method by which to connect a portable computer to the accessory device. This method may include but is not limited to, a clip, arm, magnet, or other method of attachment, or the like. When a smartphone may be attached to the accessory device, the smartphone may have the possibility of being used as a display. This display can be similar to, identical to, or perhaps even different from any other display on the accessory device. This display may extend the display on the accessory device in some embodiments.

In another form, when a portable computer may be connected to an accessory device, a display or even a plurality of displays may change states. A state change may correspond to output from a portable computer or even input from a portable computer, accessory device, or the like. A display may mirror what may be displayed on a portable computer or it may be independent. A state of a display or displays may in some way correspond to a state of the portable computer. One non-limiting example may include a system by which, when a display on a portable computer may be powered on, the display on an auxiliary device may change states.

In yet another form, when a portable computer may be linked to an accessory device, an array of buttons and/or switches such as a keyboard or the like may be used to send data to the portable computer or accessory device. A keyboard may have any plurality of keys, which may have corresponding symbols on them. An accessory device may have a touchscreen perhaps located on a base panel which may replace or even expand an analog keyboard. A touchscreen may work in a similar fashion to the keyboard.

In one form, when the smartphone may be linked to an accessory device, a pointer device such as a touchpad or the like can be used to control a pointer on the accessory device and/or the portable computer. A touchpad may be made from any metallic or plastic material or the like. In some embodiments, a touchpad may be made of glass or even a similar material or the like and may be used as a display. A display can receive data from a portable computer or accessory device and may display this data independently of or even in conjunction with any other display.

In another form, when a portable computer may be connected to an accessory device, a plurality of input and even output ports may be arranged around the accessory device. Ports may serve a number of purposes perhaps to allow for the possibility of the connection of additional accessory devices. Accessory devices can be similar to or even different from the primary auxiliary device.

In another form, a small recess may be located on an accessory device perhaps to allow a smartphone to lie flush, nearly flush, or even raised up, or the like from an accessory device's primary display.

In yet another form, an indicator or even a plurality of indicators on the accessory device may be used to display information. Information may be related to that displayed by a smartphone. Information may otherwise be related to a status of an accessory device. Uses for a display may include, but is not limited to, battery percentage, brightness of a display, or other data.

In one form, an accessory device may include a power button which can be used to turn some or even all of the features of the device to an on state or an off state. A power button may be used as a scanner, such as a biometric fingerprint reader, or the like. A scanner may send data to the smartphone.

In yet another form, a hinge may be used to orient a display of an accessory device or a display of a smartphone at a specific angle. A hinge may include, but is not limited to, some combination of a singular or plurality of gears, a tension bar or plurality of tension bars, or other mechanism by which to orient the display, or the like.

In another form, an accessory device may be used to hold a smartphone in an orientation perhaps such that a smartphone may be protected from various elements and even conditions. This may include, but is not limited to, an arm, lever, drawer, encasing, or other protection, or the like which may partially or even entirely shield a smartphone from events such as rapid acceleration towards the ground, either planned or unplanned, or the like. Protection may include electromagnetic isolation or the like. One example of this may be, but is not limited to a drawer, where a smartphone may be partially or even completely enclosed within an accessory device. A drawer such as the one described in the above example may be situated on either panel of the device or the like.

In one form, an accessory device may provide additional thermal management to a smartphone. This may include but is not limited to a fan, liquid cooling mechanism, mineral oil solution or something substantially similar, or a different means of passive and/or active thermal management. The accessory device may have a cooling system on either panel or both panels. A thermal management system may, for example, remove heat from the system via a passive vent located at a top end of the display panel. In another form, a fan connected to a piped thermal management system may be used to reduce the internal temperature immediately around various electronic components on the base of the device.

In one form, the accessory device may contain hardware which may enhance the computational capabilities of the device. In one scenario, a random-access memory (RAM) module may be present within the accessory device. Software perhaps stored either on the accessory device, on the computer, or at another location may allow the computer to use this memory to perform computations perhaps faster than it could without the aid of the accessory device. Additional pieces of computational hardware that may be present include, but are not limited to, a central processing unit, motherboard, long-term storage such as solid-state memory, a graphics processing unit, or the like. Computational hardware may be used in tandem with or even in leu of the hardware pre-installed on a device.

Naturally, further objects, goals and embodiments of the inventions are disclosed throughout other areas of the specification, claims, and drawings.

### BRIEF DESCRIPTION OF THE DRAWINGS

FIG. 1 shows a non-limiting example of a front view of a device connected to a smartphone in accordance with some embodiments of the present invention.

FIG. 2 shows a non-limiting example of a side perspective view of a device connected to a smartphone in accordance with some embodiments of the present invention.

FIG. 3 shows a non-limiting example of a device with smartphone terminal in a closed position in accordance with some embodiments of the present invention.

FIG. 4 shows a non-limiting example of a device with smartphone terminal in an open position in accordance with some embodiments of the present invention.

FIG. 5 shows a non-limiting example of a device with smartphone terminal in a partially open position in accordance with some embodiments of the present invention.

FIG. 6 shows a non-limiting example of side perspective view of a device with smartphone terminal in a partially open position in accordance with some embodiments of the present invention.

### DETAILED DESCRIPTION OF THE INVENTIONS

It should be understood that the present invention includes a variety of aspects, which may be combined in different ways. The following descriptions are provided to list elements and describe some of the embodiments of the present invention. These elements are listed with initial embodiments; however, it should be understood that they may be combined in any manner and in any number to create additional embodiments. The variously described examples and preferred embodiments should not be construed to limit the present invention to only the explicitly described systems, techniques, and applications. The specific embodiment or embodiments shown are examples only. The specification should be understood and is intended as supporting broad claims as well as each embodiment, and even claims where other embodiments may be excluded. Importantly, disclosure of merely exemplary embodiments is not meant to limit the breadth of other more encompassing claims that may be made where such may be only one of several methods or embodiments which could be employed in a broader claim or the like. Further, this description should be understood to support and encompass descriptions and claims of all the various embodiments, systems, techniques, methods, devices, and applications with any number of the disclosed elements, with each element alone, and also with any and all various permutations and combinations of all elements in this or any subsequent application.

A device described within this application may contain some, any combination thereof, or all of the following features or attributes as discussed herein. Embodiments of the present invention may provide a device with a two-panel system. A first panel, which may be a base, may be connected to a second panel, which may be a display, perhaps via a hinge. A hinge may include a series of interlocking gears which may raise a second panel when the device may be in operation. A hinge may also, in some form or another, transmit signals or even carry a signal transmission cord which may connect the two panels. A hinge may display an image, such as a logo or the like.

A display panel may include a single display of any size, which may be held within a recess in a second panel. There may be notches or other types of protrusions, recesses, or other modifications from a standard geometric shape perhaps for a plurality of input and even output devices. One non-limiting example may include a speaker system that utilizes two identical notches in the top of the display. Another non-limiting example may include a camera perhaps used to record a video or even take photos. A display panel may have multi touch functionalities.

A second panel may have an apparatus for holding an electronic device. More specifically, an apparatus may be used to hold a computer, such as a smartphone. A computer may have a display of its own, which can be used in tandem with the primary display on the accessory device or in isolation. A secondary display may have multi-touch capabilities. A secondary display may sit flush with a primary display or may even extend ahead of it. It may sit partially or even completely behind the primary display.

Embodiments of the present invention may provide an integrated computing device (1) allowing integration of technologies, which may have a display (2), a smartphone terminal (3) perhaps attached to the display, and even a joint (4) between a smartphone terminal (3) and a display (2). A display may include any act or instance of displaying information such as but not limited to a screen, monitor, projection, or the like. A smartphone terminal may be a structure to which a smartphone can be attached, set upon, connected, or the like. A smartphone terminal may be hingedly connected to an edge of a display perhaps with a joint (4) which may allow the terminal to move, swing, turn or the like. A hingedly connected smartphone terminal may be configured and even arranged to move between an open position (5) and a closed position (6). An open position may include a position of a terminal in which a smartphone can be connected to the terminal and a closed position may be a position where a smartphone cannot be connected or the like. A non-limiting example of a smartphone (9) connected to a terminal (3) in an open position (11) may be understood from FIGS. 1 and 2. FIG. 3 shows a non-limiting example of a terminal in a closed position (6) and FIGS. 5 and 6 provide non-limiting examples of a terminal in a partially open position (18). A terminal may be moved between open and closed positions perhaps by manual movement or even by automatic movement.

A smartphone terminal may be located near an edge (8) of a display when in a closed position. A smartphone terminal may be close, to a point not far away, within or the like to a display. In some embodiments, a smartphone terminal may be located substantially parallel (7), perhaps in a substantially parallel position, next to an edge (8) of a display when in a closed position. An edge (8) of a display may be any border or line of a display at which a surface may terminate and may include a top edge, a bottom edge, and perhaps even a side edge or the like. A smartphone terminal may be located substantially perpendicular (11), perhaps in a substantially perpendicular position, to an edge of a display perhaps when in an open position. By substantially parallel, a terminal may extend in a similar, same, about the same direction such as within a 0—about 30 degrees angle or more or the like as an edge of display. By substantially perpendicular, a terminal may extend at a right angle, about a right angle, such as within a 0—about 30 degrees angle or the like to an edge of display. Substantially avoids a strict boundary to a specified parameter including parallel and perpendicular. In some embodiments, a clip may be located on an edge of a display which may be configured to and even arranged to hold a smartphone terminal to an edge perhaps when in closed position.

A terminal may be configured and even arranged to receive a smartphone (9) or the like. A smartphone (9) may be a device that may combine a cell phone with a handheld computer, may be a tablet, may be a device that offers internet access, data storage, email capability, or the like. A connection may be achieved from a smartphone and a display perhaps so that the smartphone can communicate with the display and the display can show information from the smartphone. A connection may be wireless, wired, a protrusion (14) located on a terminal to which can be inserted into the smartphone such as shown in the non-limiting example in FIG. 4. When a terminal may be closed, a protrusion may be placed in a slot (13) in an edge of a display. As such a slot may be configured and even arranged to fit into a slot. A connection may provide communication between a smartphone and a keyboard (16). A smartphone may be placed on a terminal.

Embodiments of the present invention may provide a fold-out arm which may reside perhaps within close proximity to the display and can be used to hold the computer. In this non-limiting example, an arm, beam, strut, or other similarly purposed apparatus or the like may swing open via a hinge. When an apparatus may be in its extended position, a computer may be inserted. When this happens, a screen of a primary computer may be oriented at the same angle as the primary display. An apparatus may contain a physical bus, such as a male USB adapter, or the like. A connector may be used in part to secure the computer in place perhaps in such a way that it may stay in its desired position when an accessory device may be moved, rotated, shaken, or otherwise disturbed, or the like. A physical connector may be capable of moving along various axes perhaps such that it can fit a variety of different computer form factors. When an apparatus may be in its retracted state, it may sit flush with the ends of the display or even a display housing, perhaps such that it may not visibly protrude from the device.

A device may be used to send signals to a device. Signals may include, but is not limited to video or even audio output or the like. Signals may be transmitted over a USB bus, such as USB 3 or Thunderbolt or the like. A USB type C connector, Apple Lightning Connector, or other similar connector may be used to connect a computer to an accessory device.

A device may receive a signal from a single or even a plurality of input devices, such as, but not limited to, a keyboard, multi-touch pad such as a trackpad, power button, or other accessory devices connected via I/O ports on the accessory device, or the like.

An accessory device may contain a single or even a plurality of input and output (I/O) ports perhaps on any number of faces on either panel. Ports may include but are not limited to USB type C, USB type 2, USB type 3, 3.5 mm audio, VGA, Display Port, or any other commonly used bus, or the like.

A base panel may contain a power button, which can be used to turn on or off either or both the accessory device or the electronic device. A power button may be a biometric scanner, such as a fingerprint reader. A scanner may transmit data to the smartphone.

A keyboard on a first panel of an accessory device may contain any number of keys, each of which may be unique to each other key. Keys may transmit data to the electronic device, or perform some function, unique or otherwise, on the accessory device. A function may be dependent or even independent of the electronic accessory device.

A recess may be present on a first panel of the accessory device. A recess may be used in part to assist a user in raising a secondary panel to any number of different positions. An indicator may be present on a first panel of the accessory device, which can be used to display information. Specifically, an indicator can reside above a keyboard perhaps close to a display. An indicator may be lit up in a number of ways. Different lights can be used to display different data perhaps about the accessory device or even the electronic device. Data may include, but is not limited to, screen brightness, battery percentage, or any other relevant data, or the like.

The sides of a first panel of the accessory device may slope downwards. An underside of a first panel perhaps that may be closest to a user may slope upwards. This may create an effect that the device may be thinner than it actually is. A second panel of an accessory may contain a thermal management system, or the like. This may be a passive or even an active system or the like. In a passive system, ventilation slots may be present on any side of a secondary panel, but may be specifically towards a top of the panel. This can allow hot air to escape the device and may pull cold air in. In an active thermal management, ventilation slots may be present in areas similar to that of a passive cooling system, perhaps with an addition of a fan or other device used to circulate air.

A secondary panel may contain a graphic such as a logo on the back of the panel opposite of the display. A logo may light up when the device may be powered on, or perhaps even when an electronic device may be connected.

A first panel may contain a plurality of devices, such as, but not limited to, printed circuit boards (PCBs), batteries, or other electronic devices, or the like. In one embodiment, a circuit board may be used to translate input from a plurality of input devices on the accessory device or other accessory devices connected over I/O ports perhaps into a format readable for the smartphone. In another embodiment, a battery or even a plurality of batteries may be used to charge the electronic device, power the display, provide power to any other devices, or the like. A system of batteries may receive a charge from an electronic device, or even from any number of I/O ports perhaps on an accessory device.

Embodiments of the present invention may provide software which may, in part, allow a smartphone to run an operating system. An operating system may be different from the one pre-installed on a device by the manufacturer or another third party. A non-limiting example includes a system which may enable an external computer to run an operating system such as Windows or Linux or the like. When an external computer may be connected to an accessory device, an operating system perhaps other than the one installed by the manufacturer of the device may be selected to run. An alternative operating system may use the same data as the computer could use in its native mode.

A device may provide a solution which may allow an external computer to run applications perhaps not designed to run on its native operating system. This solution may include a combination of hardware and software. This solution may, in one scenario, allow use of a common pre-existing operating system, a pre-existing operating system with minor or significant modifications, a proprietary operating system not commonly in use, an open-source operating system, or other similar software, or the like. Software may be unique to the accessory device in such a way that it may interact with a portable computer in a way it could not normally in a traditional laptop. One non-limiting example may include a piece of software built into a Windows operating system which may allow for easy integration with various Android processes, such as the phone application, or the like. In one non-limiting example, a software emulation tool may be used to allow a smartphone to run an application built for Windows. In another non-limiting example, a software emulation tool may be used to allow a smartphone to run a piece of software that may be specifically designed to run on a processor with ×86 architecture on the ARM processor the device has built in or the like.

An accessory device may contain a piece of hardware, such as a printed circuit board, which may enable the computer to run an alternative operating system such as Windows or Linux or the like. A piece of hardware may contain data or even instructions which may be important or even critical to the function of the alternative operating system.

A computer may have a piece of software, such as an application, installed on the device perhaps prior to use with an accessory device. An application may contain all critical data perhaps allowing for the use of an alternative operating system. An application may be designed to work specifically with an accessory device. One non-limiting example may provide an emulation tool which may allow a user to run a Windows application on their Android phone, perhaps provided that have a peripheral device or even an array of peripheral devices which may not be native to the hardware of the computer.

In embodiments, software may store some amount of data on the computer. Data may not be accessible while the computer may be in use perhaps without the accessory device. In one non-limiting example, a Windows application could be stored in memory on a smartphone, but may only be accessible when the smartphone may be connected to the accessory device.

Embodiments of the present invention may address proper usage of the correct materials in creating a device as discussed herein. A base housing on a first panel and even a display housing on a second panel may be manufactured from a glass-reinforced epoxy laminate material, high-pressure fiberglass laminate, or the like. The rest of the first and second panels can be made from any metal or other laminate material or the like. As a non-limiting example, a material may be a lightweight metal, such as aluminum or the like. In another non-limiting example, high-tensile material such as carbon fiber or the like may be used to further protect the accessory device and even the computer, or the like.

A hinge and pivot bars may be made from a corrosion-resistant material such as but not limited to stainless steel or the like. A hinge and perhaps even pivot bars may contain a protective coating, which may prevent visible and/or functional wear or the like. A touchpad may have a tactile sensor and perhaps even a specialized surface which can translate motion and even pressure into a specific output. A device may include specialized material used as the surface, such as a glass or metal, or the like. A power button may have a biometric scanner along with a button. A biometric scanner may power on the device perhaps without the button being pressed. A covering over a biometric sensor may comprise any sort of glass or metal or the like.

As can be easily understood from the foregoing, the basic concepts of the present invention may be embodied in a variety of ways. It involves both accessory device techniques as well as devices to accomplish the appropriate accessory device. In this application, the accessory device techniques are disclosed as part of the results shown to be achieved by the various devices described and as steps which are inherent to utilization. They are simply the natural result of utilizing the devices as intended and described. In addition, while some devices are disclosed, it should be understood that these not only accomplish certain methods but also can be varied in a number of ways. Importantly, as to all of the foregoing, all of these facets should be understood to be encompassed by this disclosure.

The discussion included in this application is intended to serve as a basic description. The reader should be aware that the specific discussion may not explicitly describe all embodiments possible; many alternatives are implicit. It also may not fully explain the generic nature of the invention and may not explicitly show how each feature or element can actually be representative of a broader function or of a great variety of alternative or equivalent elements. As one example, terms of degree, terms of approximation, and/or relative terms may be used. These may include terms such as the words: substantially, about, only, and the like. These words and types of words are to be understood in a dictionary sense as terms that encompass an ample or considerable amount, quantity, size, etc. as well as terms that encompass largely but not wholly that which is specified. Further, for this application if or when used, terms of degree, terms of approximation, and/or relative terms should be understood as also encompassing more precise and even quantitative values that include various levels of precision and the possibility of claims that address a number of quantitative options and alternatives. For example, to the extent ultimately used, the existence or non-existence of a substance or condition in a particular input, output, or at a particular stage can be specified as substantially only x or substantially free of x, as a value of about x, or such other similar language. Using percentage values as one example, these types of terms should be understood as encompassing the options of percentage values that include 99.5%, 99%, 97%, 95%, 92% or even 90% of the specified value or relative condition; correspondingly for values at the other end of the spectrum (e.g., substantially free of x, these should be understood as encompassing the options of percentage values that include not more than 0.5%, 1%, 3%, 5%, 8% or even 10% of the specified value or relative condition, all whether by volume or by weight as either may be specified. In context, these should be understood by a person of ordinary skill as being disclosed and included whether in an absolute value sense or in valuing one set of or substance as compared to the value of a second set of or substance. Again, these are implicitly included in this disclosure and should (and, it is believed, would) be understood to a person of ordinary skill in this field. Where the invention is described in device-oriented terminology, each element of the device implicitly performs a function. Apparatus claims may not only be included for the device described, but also method or process claims may be included to address the functions the invention and each element performs. Neither the description nor the terminology is intended to limit the scope of the claims that will be included in any subsequent patent application.

It should also be understood that a variety of changes may be made without departing from the essence of the invention. Such changes are also implicitly included in the description.

They still fall within the scope of this invention. A broad disclosure encompassing both the explicit embodiment(s) shown, the great variety of implicit alternative embodiments, and the broad methods or processes and the like are encompassed by this disclosure and may be relied upon when drafting the claims for any subsequent patent application. It should be understood that such language changes and broader or more detailed claiming may be accomplished at a later date (such as by any required deadline) or in the event the applicant subsequently seeks a patent filing based on this filing. With this understanding, the reader should be aware that this disclosure is to be understood to support any subsequently filed patent application that may seek examination of as broad a base of claims as deemed within the applicant's right and may be designed to yield a patent covering numerous aspects of the invention both independently and as an overall system.

Further, each of the various elements of the invention and claims may also be achieved in a variety of manners. Additionally, when used or implied, an element is to be understood as encompassing individual as well as plural structures that may or may not be physically connected. This disclosure should be understood to encompass each such variation, be it a variation of an embodiment of any apparatus embodiment, a method or process embodiment, or even merely a variation of any element of these. Particularly, it should be understood that as the disclosure relates to elements of the invention, the words for each element may be expressed by equivalent apparatus terms or method terms—even if only the function or result is the same. Such equivalent, broader, or even more generic terms should be considered to be encompassed in the description of each element or action. Such terms can be substituted where desired to make explicit the implicitly broad coverage to which this invention is entitled. As but one example, it should be understood that all actions may be expressed as a means for taking that action or as an element which causes that action. Similarly, each physical element disclosed should be understood to encompass a disclosure of the action which that physical element facilitates. Regarding this last aspect, as but one example, the disclosure of a “display” should be understood to encompass disclosure of the act of “displaying”—whether explicitly discussed or not—and, conversely, were there effectively disclosure of the act of “displaying”, such a disclosure should be understood to encompass disclosure of a “display” and even a “means for displaying.” Such changes and alternative terms are to be understood to be explicitly included in the description. Further, each such means (whether explicitly so described or not) should be understood as encompassing all elements that can perform the given function, and all descriptions of elements that perform a described function should be understood as a non-limiting example of means for performing that function.

Any patents, publications, or other references mentioned in this application for patent are hereby incorporated by reference. Any priority case(s) claimed by this application is hereby appended and hereby incorporated by reference. In addition, as to each term used it should be understood that unless its utilization in this application is inconsistent with a broadly supporting interpretation, common dictionary definitions should be understood as incorporated for each term and all definitions, alternative terms, and synonyms such as contained in the Random House Webster's Unabridged Dictionary, second edition are hereby incorporated by reference. Finally, all references listed in any information statement filed with the application are hereby appended and hereby incorporated by reference, however, as to each of the above, to the extent that such information or statements incorporated by reference might be considered inconsistent with the patenting of this/these invention(s) such statements are expressly not to be considered as made by the applicant(s).

Thus, the applicant(s) should be understood to have support to claim and make a statement of invention to at least: i) each of the accessory devices as herein disclosed and described, ii) the related methods disclosed and described, iii) similar, equivalent, and even implicit variations of each of these devices and methods, iv) those alternative designs which accomplish each of the functions shown as are disclosed and described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such processes, methods, systems or components, ix) each system, method, and element shown or described as now applied to any specific field or devices mentioned, x) methods and apparatuses substantially as described hereinbefore and with reference to any of the accompanying examples, xi) an apparatus for performing the methods described herein comprising means for performing the steps, xii) the various combinations and permutations of each of the elements disclosed, xiii) each potentially dependent claim or concept as a dependency on each and every one of the independent claims or concepts presented, and xiv) all inventions described herein.

In addition and as to computer aspects and each aspect amenable to programming or other electronic automation, it should be understood that in characterizing these and all other aspects of the invention—whether characterized as a device, a capability, an element, or otherwise, because all of these can be implemented via software, hardware, or even firmware structures as set up for a general purpose computer, a programmed chip or chipset, an ASIC, application specific controller, subroutine, or other known programmable or circuit specific structure—it should be understood that all such aspects are at least defined by structures including, as person of ordinary skill in the art would well recognize: hardware circuitry, firmware, programmed application specific components, and even a general purpose computer programmed to accomplish the identified aspect. For such items implemented by programmable features, the applicant(s) should be understood to have support to claim and make a statement of invention to at least: xv) processes performed with the aid of or on a computer, machine, or computing machine as described throughout the above discussion, xvi) a programmable apparatus as described throughout the above discussion, xvii) a computer readable memory encoded with data to direct a computer comprising means or elements which function as described throughout the above discussion, xviii) a computer, machine, or computing machine configured as herein disclosed and described, xix) individual or combined subroutines and programs as herein disclosed and described, xx) a carrier medium carrying computer readable code for control of a computer to carry out separately each and every individual and combined method described herein or in any claim, xxi) a computer program to perform separately each and every individual and combined method disclosed, xxii) a computer program containing all and each combination of means for performing each and every individual and combined step disclosed, xxiii) a storage medium storing each computer program disclosed, xxiv) a signal carrying a computer program disclosed, xxv) a processor executing instructions that act to achieve the steps and activities detailed, xxvi) circuitry configurations (including configurations of transistors, gates, and the like) that act to sequence and/or cause actions as detailed, xxvii) computer readable medium(s) storing instructions to execute the steps and cause activities detailed, xxviii) the related methods disclosed and described, xxix) similar, equivalent, and even implicit variations of each of these systems and methods, xxx) those alternative designs which accomplish each of the functions shown as are disclosed and described, xxxi) those alternative designs and methods which accomplish each of the functions shown as are implicit to accomplish that which is disclosed and described, xxxii) each feature, component, and step shown as separate and independent inventions, and xxxiii) the various combinations of each of the above and of any aspect, all without limiting other aspects in addition.

With regard to claims whether now or later presented for examination, it should be understood that for practical reasons and so as to avoid great expansion of the examination burden, the applicant may at any time present only initial claims or perhaps only initial claims with only initial dependencies. The office and any third persons interested in potential scope of this or subsequent applications should understand that broader claims may be presented at a later date in this case, in a case claiming the benefit of this case, or in any continuation in spite of any preliminary amendments, other amendments, claim language, or arguments presented, thus throughout the pendency of any case there is no intention to disclaim or surrender any potential subject matter. It should be understood that if or when broader claims are presented, such may require that any relevant prior art that may have been considered at any prior time may need to be re-visited since it is possible that to the extent any amendments, claim language, or arguments presented in this or any subsequent application are considered as made to avoid such prior art, such reasons may be eliminated by later presented claims or the like. Both the examiner and any person otherwise interested in existing or later potential coverage, or considering if there has at any time been any possibility of an indication of disclaimer or surrender of potential coverage, should be aware that no such surrender or disclaimer is ever intended or ever exists in this or any subsequent application. Limitations such as arose in Hakim v. Cannon Avent Group, PLC, 479 F.3d 1313 (Fed. Cir 2007), or the like are expressly not intended in this or any subsequent related matter. In addition, support should be understood to exist to the degree required under new matter laws—including but not limited to European Patent Convention Article 123(2) and United States Patent Law 35 USC 132 or other such laws—to permit the addition of any of the various dependencies or other elements presented under one independent claim or concept as dependencies or elements under any other independent claim or concept. In drafting any claims at any time whether in this application or in any subsequent application, it should also be understood that the applicant has intended to capture as full and broad a scope of coverage as legally available. To the extent that insubstantial substitutes are made, to the extent that the applicant did not in fact draft any claim so as to literally encompass any particular embodiment, and to the extent otherwise applicable, the applicant should not be understood to have in any way intended to or actually relinquished such coverage as the applicant simply may not have been able to anticipate all eventualities; one skilled in the art, should not be reasonably expected to have drafted a claim that would have literally encompassed such alternative embodiments.

Further, if or when used, the use of the transitional phrase “comprising” is used to maintain the “open-end” claims herein, according to traditional claim interpretation. Thus, unless the context requires otherwise, it should be understood that the term “comprise” or variations such as “comprises” or “comprising”, are intended to imply the inclusion of a stated element or step or group of elements or steps but not the exclusion of any other element or step or group of elements or steps. Such terms should be interpreted in their most expansive form so as to afford the applicant the broadest coverage legally permissible. The use of the phrase, “or any other claim” is used to provide support for any claim to be dependent on any other claim, such as another dependent claim, another independent claim, a previously listed claim, a subsequently listed claim, and the like. As one clarifying example, if a claim were dependent “on claim 20 or any other claim” or the like, it could be re-drafted as dependent on claim 1, claim 15, or even claim 25 (if such were to exist) if desired and still fall with the disclosure. It should be understood that this phrase also provides support for any combination of elements in the claims and even incorporates any desired proper antecedent basis for certain claim combinations such as with combinations of method, apparatus, process, and the like claims.

Finally, any claims set forth at any time are hereby incorporated by reference as part of this description of the invention, and the applicant expressly reserves the right to use all of or a portion of such incorporated content of such claims as additional description to support any of or all of the claims or any element or component thereof, and the applicant further expressly reserves the right to move any portion of or all of the incorporated content of such claims or any element or component thereof from the description into the claims or vice-versa as necessary to define the matter for which protection is sought by this application or by any subsequent continuation, division, or continuation-in-part application thereof, or to obtain any benefit of, reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon.

What is claimed is:

1. An integrated computing device comprising:
a display;
a hingedly connected smartphone terminal attached to said display;
a joint between said hingedly connected smartphone terminal and said display;
wherein said hingedly connected smartphone terminal is configured and arranged to move between an open position and a closed position using said joint;
wherein said hingedly connected smartphone terminal is located near an edge of said display in said closed position;
wherein said hingedly connected smartphone terminal is configured and arranged to receive a smartphone; and
a connection between said smartphone and said display.

2. The device as described in claim 1 wherein said hingedly connected smartphone terminal located near an edge of said display in said closed position comprises said hingedly connected smartphone terminal located substantially parallel to an edge of said display in said closed position.

3. The device as described in claim 1 wherein said hingedly connected smartphone terminal is located substantially perpendicular to said edge of said display in said open position.

4. The device as described in claim 1 and further comprising a clip on said edge of said display.

5. The device as described in claim 4 wherein said clip is configured and arranged to hold said hingedly connected smartphone terminal to said edge of said display when in said closed position.

6. The device as described in claim 1 and further comprising a manual movement of said hingedly connected smartphone terminal between said open position and said closed position.

7. The device as described in claim 1 and further comprising an automatic movement of said hingedly connected smartphone terminal between said open position and said closed position.

8. The device as described in claim 1 and further comprising a slot in said edge of said display and a protrusion on said hingedly connected smartphone terminal.

9. The device as described in claim 8 wherein said protrusion is configured and arranged to fit into said slot.

10. The device as described in claim 1 wherein said edge of said display is chosen from a top edge, a side edge, and a bottom edge of said display.

11. The device as described in claim 1 wherein said hingedly connected smartphone terminal is located on a side edge of said display.

12. The device as described in claim 1 wherein said connection between said smartphone and said display is chosen from a wired connection and a wireless connection.

13. The device as described in claim 1 and further comprising a keyboard.

14. A method of integrating technologies into a device comprising the steps of:
providing a smartphone terminal hingedly connected to a display;
moving said smartphone terminal between an open position and a closed position;
placing said smartphone terminal near an edge of said display when in said closed position;
placing a smartphone on said smartphone terminal when in said open position;
connecting said smartphone and said display.

15. The method as described in claim 14 wherein said step of placing said smartphone terminal near an edge of said display when in said closed position comprises the step of placing said smartphone terminal in a substantially parallel position next to an edge of said display when in said closed position.

16. The method as described in claim 14 and further comprising the step of placing said smartphone terminal in a substantially perpendicular position to said edge of said display when in said open position.

17. The method as described in claim 14 and further comprising the step of placing a protrusion of said smartphone terminal in a slot in said edge of said display when in said closed position.

18. The method as described in claim 14 wherein said step of connecting said smartphone and said display comprises a connection chosen from a wired connection and a wireless connection.

19. The method as described in claim 14 wherein said step of moving said smartphone terminal between said open position and said closed position comprises the step of automatically moving said smartphone terminal between said open position and said closed position.

20. The method as described in claim 14 wherein said step of moving said smartphone terminal between said open position and said closed position comprises the step of manually moving said smartphone terminal between said open position and said closed position.
